(19) United States
(12) Patent Application Publication
(10) Pub. No.: US 2015/0143234 A1
(43) Pub. Date: May 21, 2015

(54) ERGONOMIC MICRO USER INTERFACE DISPLAY AND EDITING

(71) Applicant: Forbes Holten Norris, III, Princeton, NJ (US)

(72) Inventor: Forbes Holten Norris, III, Princeton, NJ (US)

(21) Appl. No.: 14/521,448

(22) Filed: Oct. 22, 2014

Related U.S. Application Data
(60) Provisional application No. 61/893,897, filed on Oct. 22, 2013.

(51) Int. Cl. G06F 17/24; G06F 3/0488

(52) U.S. Cl. CPC G06F 17/24; G06F 3/04886
USPC 715/256

(57) ABSTRACT

A method and apparatus is disclosed for more efficient editing and reading comprehension of text and other content on a computer screen with a virtual keyboard and limited space, such as would be found on a mobile device such as smartphone, tablet, handheld computer or an automobile dashboard, or an appliance with a small screen. The method provides aids that assist in Saccadic related cognition of limited text display, especially condensed or abbreviated text. The method also employs macro population analysis to better understand and adapt to the ergonomic typing and reading challenges of mobile device usage in specific circumstances.

### CROSS REFERENCE TO RELATED APPLICATION

This application claims priority to provisional application No. 61/893,897, filed Oct. 22, 2013, the entire contents of which are incorporated herein by reference.

### FIELD OF THE INVENTION

Digital device software user interfaces (UI), particularly small mobile portable devices.

Virtual keyboards typically used on computer touch screen devices such as ordering kiosks, industrial control screens, auto dashboard screens, mobile devices like smartphones, tablets, music players, tablets, laptop hybrids, and “wearables” like smart watches.

Virtual keyboards used in computer virtual reality display screens such as projector eyewear, headgear, helmets, glasses, goggles like Google Glass, military heads up displays, game consoles like the Nintendo Wii, Microsoft Kinect, etc.

Menu based user interfaces found in computer applications (apps) on small, cramped information dense screens, involving lots of options requiring highly precise, complex sequences of choices and steps; examples are mobile device “apps” or games; military heads-up control systems; robotic medical or industrial device control systems, etc.

Small, portable mobile computer device display screens and user interface software.

Virtual keyboard word completion suggestion menus.

User interface suggestion hints.

“Wearable” mobile devices such as smart watches like the Samsung Gear or heads up display style devices like Google Glass which are worn like sunglasses or vision correction glasses.

Remote control user interface devices like mice, micro size keyboards, joysticks, “wearables” like smart watches.

Word abbreviation.

Eye tracking software.

### BACKGROUND OF THE INVENTION

Radically increasing information, in combination with radically shrinking screens, is a fundamental paradox and urgent challenge of the mobile device revolution, arguing for radically more flexible mobile user interfaces.

Technology (computers, internet, wireless networks, etc.) gives rapid, convenient access to almost limitless amounts of data, while mobile devices are simultaneously shrinking display and user interface (UI) mechanisms, making information more cumbersome to interact with, a serious limitation of such devices, even with improved screen resolutions.

Mobile device (mobile) specific UIs generally address limited display size by sacrificing information density, for example by showing larger text letters but fewer lines of text. Common designs collapse content by hiding entire sections, replacing them with short headline style summaries, while also providing content detail hide and show toggle controls.

However, seeing larger chunks of information, particularly text, together in context is very valuable, because the larger meaning of most all most text information is greatly influenced by the context of preceding text and images.

Saccadic eye movements (http://en.wikipedia.org/wiki/Saccade) describe how when reading our eyes frequently unconsciously scan back to previously viewed material, (http//:en.wikipedia.org/wiki/Eye_movement_in_reading) providing compelling evidence that seeing preceding text in proper context is very important to efficient comprehension.

Abbreviation is a useful tool for compacting text on small screens, for example with detailed methods described in the U.S. Pat. No. 6,279,018 B1 patent. However, even with such methods, seeing adequate context is problematic; in fact compacting methods can introduce ambiguity which requires even better context to resolve.

Text editing can potentially be simplified by word completion based on understanding how phonetic “sounds like” misspellings map to valid words. An example is seen in the U.S. Pat. No. 7,831,911 B2 spell checking patent.

Mobile devices also pose unique ergonomic challenges poorly addressed by traditional desk top user interfaces. What's needed are better mobile device UIs which learn from larger macro user population mistakes and corrections in myriad ergonomically challenging situations.

### SUMMARY OF THE INVENTION

The enclosed invention discloses methods for improving rapid comprehension and editing of condensed, abbreviated text, which involve adaptations to assist Saccadic eye movement based reading cognition.

Methods are also disclosed which provide auto-correction learning systems, based on macro user statistical analysis, designed to facilitate faster, easier, more accurate typing, and systems which anticipate and dynamically adjust to ergonomically challenging conditions by providing less error prone, customized user interfaces.

### DESCRIPTION OF THE DRAWINGS

FIG. 1 shows a typical small computer device virtual screen keyboard editing and display apparatus.

FIG. 2 shows how context hints enhance comprehension of limited, condensed, and abbreviated text, including providing support to Saccadic cognition.

FIG. 3A shows a method of condensing text using progressively smaller font size the farther each line is from the user's current reading or editing location.

FIG. 3B shows the same condensed text display method in FIG. 3A but overlaid with a transparent keyboard using predictively generated variable size keys.

FIG. 3C shows condensed text overlaid with a transparent keyboard using a predictively generated limited key set.

FIG. 3D shows condensed text overlaid with a transparent keyboard using a predictively generated limited key set in an ergonomic thumb typing layout.

FIG. 4A shows a typical paragraph of text as conventionally displayed where each line has uniform font size and line spacing, etc.

FIG. 4B shows a method of condensing text display by interleaving lines of text such that lines farther from the user's current reading or editing location are lighter in shade.

FIG. 4C shows a method of condensing text display similar to FIG. 4B but adding variable font sizing so that text more distant from the current reading or editing location is progressively relatively smaller.

### DETAILED DESCRIPTION

### Mobile Device User Interface

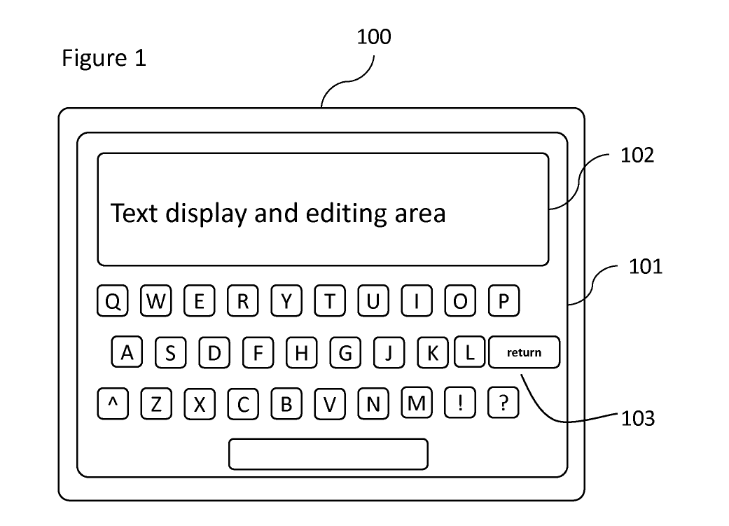

FIG. 1 illustrates the primary UI regions of a typical mobile touch screen device. Item 100 shows the device outer edges, Item 101 shows the virtual touch screen area, Item 102 shows the content display and edit screen region, and Item 103 shows the virtual keyboard.

### Recording User Interface Mistakes and Corrections

Typing mistakes and related corrections typically involve actions like letter and word deletions, and retyping.

On small mobile screens such mistakes and corrections correspond to unique ergonomic signatures or footprints which can be recorded and statistically analyzed for creation of auto-correction error prevention strategies.

Such footprint signatures consist of multiple device configurations and states, such as applications in use, user hand dimension, and the specific UI being used; For example a texting app, involving variables like single or double hand thumb typing, keyboard dimensions and orientation (portrait or landscape).

Whenever a UI corrections happens, the details, along with ergonomic footprints are recorded and stored by the system in the device internal memory, and eventually transferred and stored on a more central computer system for future macro analysis.

Recorded device details include physical factors like weight, dimension, internal storage, screen size and resolution, and processor speed. Device state is also recorded, including time and date, battery charge, software updates, etc. also things like screen orientation, brightness, and external lighting conditions.

Recorded keyboard details include the application involved, application state, visual settings (e.g. font sizes), keyboard style (for example QWERTY or Dvorak), orientation, screen position and location.

Touch screen interaction details, if available, are recorded, such as keystroke or touch speed, pressure, single or double taps, single or multi-touch fingers, and gestures (swipe up or down, etc.).

Sensors in the device also try to record the exact shape, position and placement of the user's hands relative to the device. For example camera lenses and pressure sensors on the back and sides of the device can be employed for this purpose.

The system collects similar data about any relevant wireless or wired remote control user interface devices, such as mice, “wearables” like smart watches, joysticks, micro size keyboards, or 3D hand or finger motion position sensing devices. For example, a user may wirelessly control a smart phone music app via a smart watch device virtual screen or physical buttons.

States and configurations potentially affecting screen interaction are recorded, including factors like location, external lighting, device movement (e.g. driving or exercising on a treadmill, etc.). Such data can be recorded from mobile device sensors like cameras and microphones, which for example might be able to tell if you're presently on a crowded, noisy, poorly lit subway train.

The device can also attempt to gather information wirelessly from nearby sensors and local wireless networks, etc. for example a home lighting smart system may provide details of local room lighting conditions.

The device can also try to collect data on a user's physical and emotional state, for example levels of fatigue, alertness, interest, engagement, even drug related impairment, potentially gleaned from things like posture, speed and accuracy of device usage, facial expression, body language, eye movement.

The type and amount of data collected will vary greatly depending on relevance, context, state, economy and efficiency. Highest priority is given to the most relevant data which is also the most economical and efficient to collect, depending on factors like current battery charge, the strength of local wireless networks, current device processor load, available local storage capacity. For example device local sensor data will generally be given highest priority, since it typically consumes less power.

Similar data is collected and aggregated for macro populations of users using similar devices, applications, states and configurations. Such macro groups may involve millions of users. Individual user identity is always kept strictly anonymous when collected and aggregated this way.

As the system learns which factors most directly affect UI input mistakes, it prioritizes, limits and fine tunes data collection to just the most relevant factors for each individual user.

When a reasonable amount of actionable data has been compiled, statistical methods are invoked to predict the most likely corrections for each error, based on situation and context.

Until a user has a long enough correction history, the system will rely on aggregated macro population statistical predictions. To increase speed and efficiency, only the most common, highest priority correction data will be pre-loaded, depending on available local system storage capacity.

### Virtual Keyboards

Far too much of cramped mobile device keyboard real estate is devoted to infrequently used letters and keys.

The invention dynamically hides or removes letter keys which are unneeded or irrelevant in specific contexts, which can be determined automatically by statistical analysis, and even user preference. For example, as the user types, the most likely next letter keys can become larger, while least likely become smaller or hidden. The most likely letter keys can also display word or word fragment completion options.

The invention provides menus to allow users to specify which keyboard letters they need or don't need in specific application, device and situational contexts, allowing more space for other keys or UI controls.

Statistical analysis can also be chosen to automatically determine which UI components are most and least useful in specific situations; the most useful can be made larger and more accessible, while the least useful can be shrunk or hidden, greatly increasing available screen space for the higher priority UI elements.

For example international patent application PCT/US2014/031121 describes keyboards with variable size keys based on relevance. For example, if the system determines that a particular macro user group is unlikely to use certain keys while thumb typing texting on subway trains, those irrelevant, low priority keys could be hidden, freeing up space for other keys to become larger in size and easier to use.

### Overlapping Virtual Keyboard and Editable Text Input Areas

Because of space constraints, mobile virtual keyboards often greatly limit the visible text editing display area to just a few lines. This can make editing difficult when the user can see only a small fraction of a larger thought context, for example a paragraph length message. The lack of visible context, partially related to Saccades eye movements, hinders the editing thought process, and can also make it difficult to navigate to where additional edits are needed.

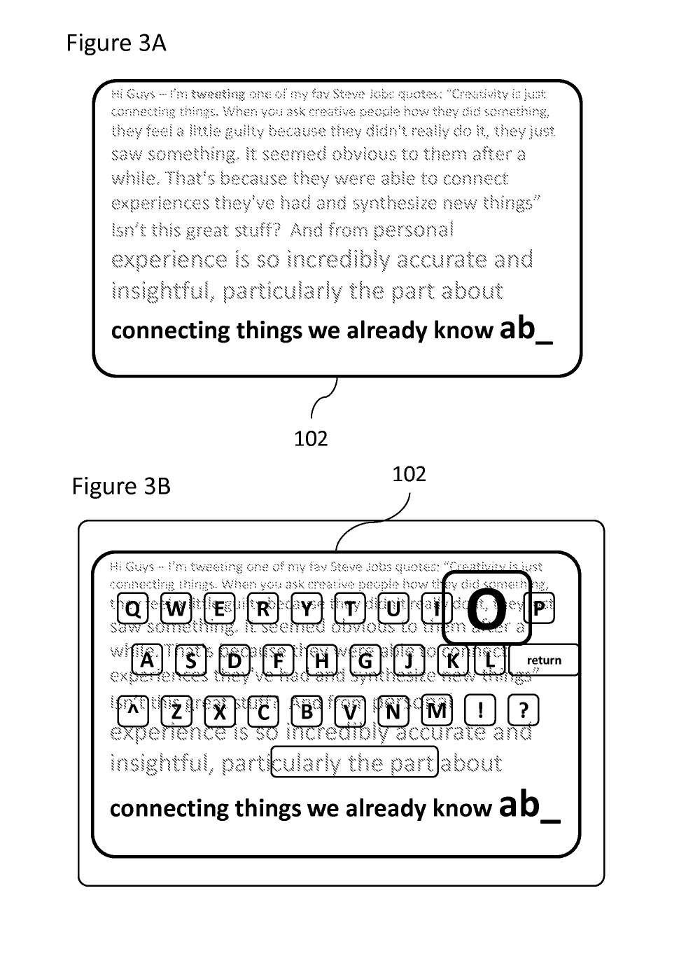

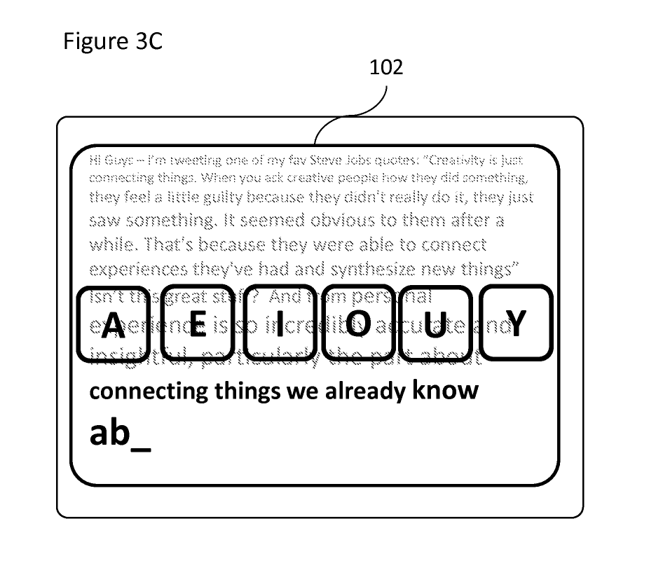

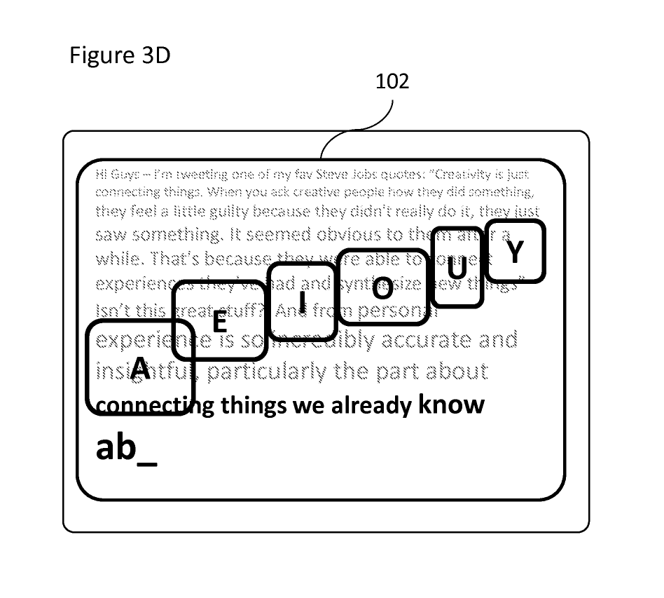

The enclosed invention provides a reasonable workaround by allowing keyboards and edit content to share the same space. This is accomplished by transparent foreground keyboards that overlap, overlay and float over background content, providing a limited but “good enough” content view, while providing a clear view of the exact text location being edited. This is illustrated in FIG. 3B which shows the keyboard overlaying the content of FIG. 3A.

In FIG. 3B, the “O” key is also shown in larger size, illustrating how the system has given it a high priority, judging it being the next most likely relevant letter to be entered, following the edit focus point word fragment of “ab” shown in large font at bottom of the edit display area, thus anticipating the typing of “about”.

Foreground keyboard and background text can be distinguished from each other via distinct fonts, shades and colors, borders and highlight graphics, typically lighter, faded and de-emphasized in the background, while darker, brighter, bolder in the foreground.

Foreground keyboards and background content are typically distinguished from each other by via distinct fonts, shades, colors, borders and highlight graphics, with normally lighter and de-emphasized backgrounds, and darker, brighter, bolder, and highlight emphasized foregrounds.

FIGS. 3C, 3D illustrate how overlapping keyboards can be even more useful when combined with a reduced keyset such as described in international patent application no. PCT/US2014/031121, where fewer keys mean the underlying content becomes much more visible. Both FIG. 3C, 3D shows just vowel keys, which can be the only relevant keys following certain consonants. FIG. 3D shows an ergonomic thumb typing layout FIGS. 3C, 3D illustrate how overlapping keyboards can be even more useful when combined with a reduced keyset such as described in international patent application no. PCT/US2014/031121, where fewer keys mean the underlying content becomes much more visible. Both FIGS. 3C and 3D show just vowel keys, which can be the only relevant keys following certain consonants. FIG. 3D shows an ergonomic thumb typing layout.

### Condensed, Abbreviated Content

Stripping down and streamlining text to bare “good enough” essentials can greatly speed typing, increase small screen information density, and also reduce network traffic and mobile device power requirements.

The invention condenses and abbreviates content via a flexible formula of one or more approaches: spelling abbreviation and shortcuts, paraphrasing, and stripping out implied words (some of these basic abbreviation methods are described in U.S. Pat. No. 6,279,018 B1 prior art patent). These approaches are also applied to traditional mobile section header, headline, content detail hide and show controls.

Condensed content can typically be slow and difficult to read and require learning entirely new shortcut vocabularies. The invention however can actually speed reading and comprehension by retaining “good enough” spelling, while stripping out non-essential letters and content, in much in the way that music and audio compression like MP3, etc. strips out less relevant detail. Another analogy is JSON vs. XML data formats; JSON is a limited but “good enough” XML representation, which significantly reduces the volume of XML data.

The abbreviation formula can be dynamically adjusted and optimized for various contexts such as device hardware, operational conditions, user correction history and user preferences. For example if the software determines that the user is noticeably tired, or that lighting conditions are tricky, the invention can make compensating adjustments.

Reading on small screens is challenging, typically involving a fair amount of effort, but greater information density can reduce this friction significantly and actually speed reading, by reducing scrolling and other navigation, but particularly by allowing context to help fill in implied detail; this is a self-reinforcing concept and pattern, as the greater the information density, the clearer the implied context to the reader, permitting, up to a point, even greater levels of abbreviation. For example the abbreviated words “chld” and “mnu” can be ambiguous in isolation, but become much clearer when paired together “chld mnu” (child menu) due to the mutually reinforcing context, for example when used in a fast food ad. Thus within the context of “chld mnu” additional abbreviations are also clearer, like dscnt, brgr, sda (discount, burger, soda, etc.)

Increased information density via compression can potentially increase reading speed by reducing the amount of challenging small screen reading and navigation, The goal is limited shortcuts and abbreviations, based on a few simple, intuitive rules, which preserve general spellings, thus don't require specialized learning and memorization of tricky and complex shorthand vocabularies.

The guiding principles are “sounds like”, spellings which sound and look close enough to correct spellings, thus immediately comprehended; letters, even words, implied clearly enough by surrounding context can be stripped out; combinations of multiple shorthand strategies are valid as long as the meaning is quickly clear and “good enough”. Fewer than 100 words constitute the majority of written text volume, so those words are the most likely to be removed or truncated.

In most cases of ambiguity meaning is generally clear enough provided adequate context. For example “document” and “doctor” typically share the same “doc” abbreviation. However, in most cases, meaning is clear enough from the context.

Macro statistical analysis is used to discover the best, most commonly used shortcuts in specific language and demographic populations. Shortcuts can also be symbols or numbers that sound like words (“to” sounds like “2”). The invention also automatically understands and accepts “sounds like” misspellings without requiring corrections.

Accepting Mistakes anad Misspellings

A significant amount of typical writing time and effort can be spent on getting the spelling right, which can greatly slow text editing, particularly on mobile devices.

In order to speed typing, the invention accepts a wide range of uncorrected mistakes and common misspellings, including the types of abbreviations described in the U.S. Pat. No. 6,279,018 B1 patent.

For example number spellings can be shortened to numbers, thus “two” becomes “2”.

English language double consonants and some silent letters can be removed, particularly where not significantly impairing meaning, and where correct meaning is clear enough from the context.

Sounds like Simplified Spelling

“Sounds like” spelling involves just a few simple rules. Many common but tricky and confusing grammar rules can be discarded. Words can be validly spelled closer to what they sound like, particularly when resulting in shortened or simplified spelling of more common words, but where meaning remains reasonably clear and unambiguous, based on adjacent context.

“Sounds like” spelling can involve entire words or just subsections, for example word prefixes and or suffixes.

For example double consonants can usually be condensed to a single consonant, because to most, the single sounds like the double and the meaning is clear enough. Additionally there's the significant advantage of simplified spelling, avoiding tricky hard to remember grammar rules.

Simple examples: “are” becomes ‘r’, “be” becomes ‘b’, “see” becomes ‘c’, “too” becomes ‘2’, “you” becomes “u”, etc.

Minor but common “sounds like” mispronunciation spellings are acceptable, For example: “entrepreneur” can acceptably be spelled “entrepenur” or “ontrapenur”.

Misspelling mistakes are ok when they sound close enough to the correct spelling, particularly involving vowel combination misspellings; for example “weildy”, “recieve, receeve, receve” are valid “sounds like” equivalents of “wieldy”, “receive” respectively.

Short phrases can use sounds like abbreviations, for example “see you” can be expressed as “c u” or just “cu”.

### Pronunciation Hints

The meaning of abbreviated words and phrases can be improved by selective visual emphasis or highlighting of certain pronunciation emphasis letters.

Emphasis can be any combination of bigger, bolded, distinctly colored, underlined, distinct font, angle or shape, including graphics like borders, etc.

Such emphasis can be dynamically applied to just the words, phrases, sentences, lines, content sections the user is gazing at, as determined by eye tracking software.

### Prefix and Suffix Truncation

Many suffixes can be easily truncated by removal of double consonants and certain vowels immediately preceding and or following an ending consonant, particularly where vowels are silent or the sound is implied; where “sounds like” concepts apply, and meaning is reasonably implied by adjacent letter or word context.

Suffix examples: ed->d, er->r, fully->fuly, ier->“er, r”, ing->g, ion->un, tion->shun, ious->shus.

Prefixes can remove silent vowels; examples: express->xpres, exchange->xchange, encode->ncode, embrace->mbrace, decode->dcode.

### Abbreviation Combinations

Words can be condensed or abbreviated combining multiple rules and techniques. Examples (where “->” means “becomes” or “can become one the following list”):

accommodate->“acomodat”, action->“actun, acshun, akshun”, agile->“agil”, aisle->“ile, iul”, ambitious->“ambishus”, anonymous->“anonomus”, analyzed->“analizd”, beautifully->“beautifuly, beautifly”, between->“btween”, bigger->“bigr”, battery->“battery”, color->“colr”, committed->“comitd”, connection->“conexshun, conexion”, corollary->“coralary”, correct->“korect”, different->“difrnt”, enough->“enuf”, frosting->“frostg”, have->“hav”, highlighted->“hilited, hilightd”, happier->“hapyer, hapyr”, impressive->“impresiv”, maneuver->“manuver”, manufacture->“manufactr”, manufacturing->“manufactorg”, masculine->“masculin”, millennium->“milenium, mileneum”, miniature->“minature”, mischievous->“mischivus”, misspelling->“mispelng”, phone->“phon”, primarily->“primarly”, recommended->“recomndd”, speakerphone->“speakrphon”, superstar->“suprstr”, technique->“teknique, tekneek”, though->“tho”, well->“wel”, would->“wood, wud”.

Multiple types of abbreviation are possible, depending on contextual need, for example fearlessness->“fearlesnes, fearlesns, fearlsns”. necessarily->“necesarly, nesesarly, nesesarli”.

“Sounds like” spelling is used, particularly if shortening common or long and complex, tricky spellings, and where the “sounds like” version doesn't overlap or create ambiguity with other words. For example, an incorrect spelling like “weildy” is ok as long it sounds reasonably enough like the correct spelling “wieldy”.

Other examples: receive->“receive, receeve, receve, recev”, maintenance->“maintanance, maintinence”, simultaneously->“simultaneusly, simultaneusli, simultaneuslee”.

### Paraphrased Content

The invention can automatically generate paraphrased text content that's “good enough”, while significantly reducing the number of words required to convey the meaning, much the way shorthand is commonly used in texting applications.

### Removal of Implied Words

Many of the most common shorter words can be removed since their meaning easily is understood or implied by contextually derived implication, thus the invention typically strips out common words like “a”, “it”, “it's”, “the”, etc.

Frequently repeated words can be shortened, so for example after initial use, the word “watch” can be shortened to “wtch”. When used in lists, “and” can be replaced by “,” or “/”. Certain punctuation can be removed, for example “can't” can become “cant”. Longer words can in some cases be replaced by shorter words which convey a reasonably similar meaning in a given context. Entire phrases can also be abbreviated, e.g. “in order to” can be shortened just “to” or “2”

Implied words can be removed, e.g. “you can purchase it at Walmart” can be abbreviated “can purchase at Walmart” or “purchasable at Walmart” or “available at Walmart” or “avlble at Wlmrt”.

The invention can highlight key words and phrases which aid faster comprehension of the key points likely to be of greatest interest, which can be determined from an in-depth analysis of a user's public online digital footprints, e.g. social media, blog posts, etc. Such highlighting techniques can be used to reduce power usage, since only key words require optimal brightness levels.

Levels of text compression can be settable by users. Text can be automatically translated back and forth from compressed to richer, non-abbreviated forms. Such compression can also be used to reduce power consumption and improve network speed as there's less data to transmit, process and display.

### Implied Context

Implied context “hints”, where helpful, can be explicitly displayed, for example at the start or end of current screen content. Multiple levels of global and local context can be displayed in order of level, for example global starting on the left, becoming more local farther to the right. Context hints are useful because they help substitute for off screen preceding text, which helps support the Saccadic cognition thought to be involved with reading comprehension. Context hints can be used with or without condensed, abbreviated text.

Context metadata itself can also be displayed in abbreviated, condensed form. For example the context “Samsung Watch” can be shown as “Smsg” Wtch”. Or the abbreviation “Chld Mnu” could be shown as the context for fast food menu item abbreviations like “brgr”.

The UI can display more detailed context on demand via user gestures such as a long press on the exact line or words of interest.

### Example of Multiple Techniques for Display Size Conservation:

Original Text:
“The Samsung smart watch is huge, but it's beautifully disguised to hide its hugeness. You can buy it with a plastic wristband in different colors. You can't exchange the bands, though, because important elements are built into it a micro-speakerphone in the clasp and a tiny camera lens in the band.”

Basic Abbreviation, about 20% fewer characters (Samsung is implied global context):
“watch is huge, but well disguisd 2 hide hugenes. u can buy with plastic wristbnd in difernt colors. u cant xchange bands, tho, cuz important elements are built in: micro-speakrphon in the clasp and tiny camera lens in band.”

The implied global context for the next examples is “Samsung smart watch” or just “watch”

Advanced Abbreviation, about 30% fewer characters (“Samsung smart watch” or just “watch” is implied global context):
“huge, but wel disguisd 2 hide hugenes. sold w/plastic wristbnd in difrnt colrs. cant xchange bands, tho, cuz important things r built in: micro-speakrphon in clasp, tiny camera lens in the band.”

Maximum Abbreviation, about 60% fewer characters with highlighted words of greatest interest. In this case the user's previous interest in mobile photography could've been ascertained by frequent mobile device Instagram photo postings to social media like Facebook and Tumblr. (“Samsung smart watch” or just “watch” is the implied global context):
“huge, but ok. plastic wristbnd in difernt colors. micro-speakrphon in clasp, tiny camera lens in the band.”

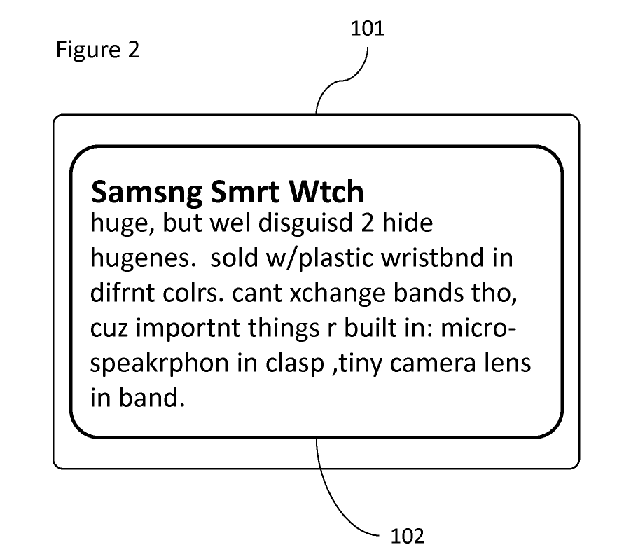

FIG. 2 shows an advanced abbreviation example where the bolded “Samsng Smrt Wtch” at the top of the display is the implied context, which is itself also abbreviated, representing “Samsung Smart Watch”. This implied context hint example also illustrates how more global context is displayed at the left (Samsung), while more local context (Smart Watch) is progressively displayed to the right. Multiple nested levels of context can be displayed with separators, for example “Samsung->SmartWatch->Apps->Messaging” (messaging apps for Samsung smart watches) which also illustrates the tree like nature of context, where “Samsung” is the top level root parent context and each subsequent context to the right represents a child branch context deeper farther down the context tree.

### Eye Tracking

Real time eye tracking software can be used to dynamically highlight and or magnify the exact content the user is looking at. As user gaze changes, relevant context hints, where applicable, can also be dynamically displayed in highlighted fashion within the user's gaze field. Requests for additional or more detailed context information can be signaled via gestures like a long stare or even eye blink or by explicit touch or tapping gesture.

Eye tracking is also used to better understand saccadic eye reading movements, allowing for dynamic highlighting of the exact content corresponding to areas of the user's gaze.

Eye tracking can also be used to better understand which content is likely of greatest interest, thus providing hints as to which content should be highlighted or made more accessible and visible, with important implications for optimization of mobile advertising, particularly because mobile ads can be proximity, location based, and often viewed in varying and challenging conditions.

### Optimizing Limited Space

The invention makes more efficient use of limited screen space by prioritizing content in custom context specific ways, typically giving higher priority content better accessibility and lower priority content reduced accessibility, where accessibility means any combination of size, space, emphasis, location, touch sensitivity, etc.

Where helpful implied context ‘hints’ can be explicitly displayed, preferably in condensed form, for example at the start or end of the screen content current view, almost like condensed micro headlines. As the user reads and scrolls forward or backward, the relevant context hints dynamically change as well, since the context is specific to each content section.

Any content prior to the current reading line or word location is implied context to the current reading position; this is particularly true since research indicates that human eyes do not read or move a smooth continuous, linear fashion, but rather human cognition involves a data sampling method, scanning of often multiple content locations in a discontinuous manner, called Saccadic eye movements (http://en.wikipedia/org/wiki/Saccade).

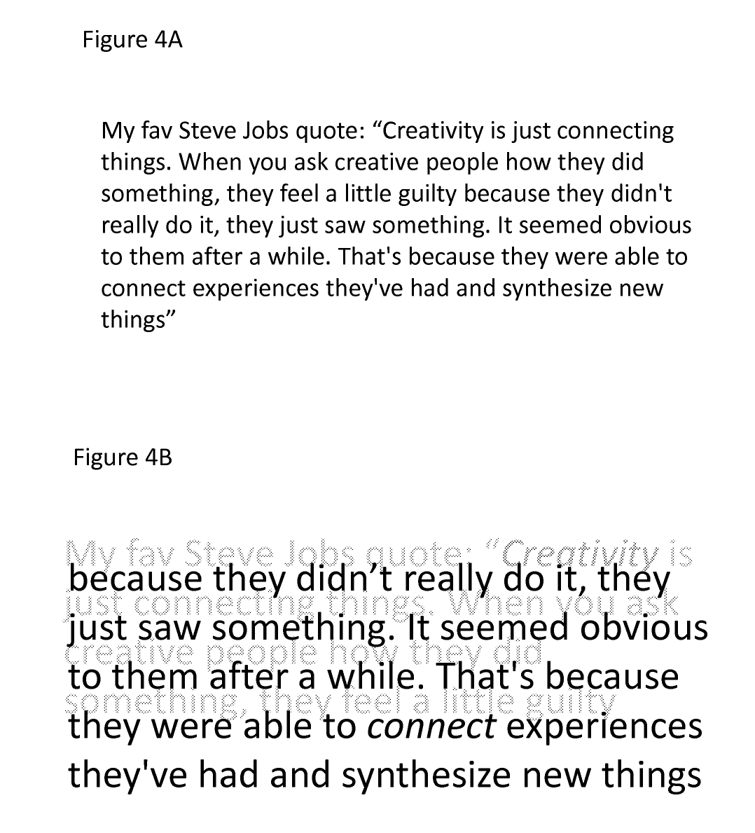

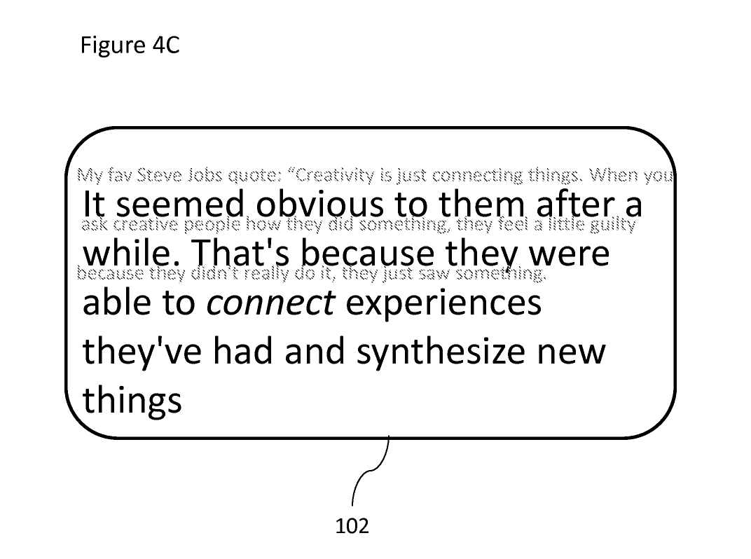

To enhance this process, the invention allows prior content lines to be simultaneously displayed in a background manner interleaved inside the normally blank vertical space between the text lines of more current, higher priority content (closer to the current reading focus location), which is illustrated in FIGS. 4A-4C

This effectively interleaves or interlaces higher with lower priority content, creating higher information density, allowing unconscious Saccadic eye movements to see more in less space.

This background text (FIGS. 4B-C) can be shown in a faded out, de-emphasized style, via any combination of lighter font color or shade and or smaller size, smaller fonts, reduced intra-character space between letters, while more relevant higher priority content is shown in the foreground, layered on top of background content, using visual emphasis display styles, involving any combination of larger fonts with bolder, darker, brighter or contrasting styles and colors, including more generous font spacing. Foreground can overlap background text to some extent, as long as background text display is “good enough”. Contrasting colors can be used to help distinguish foreground and background text.

The general display rule is that nearby, closer content is visually emphasized in the foreground, while farther, more distant prior content is shown faded in the background, mimicking the visual effect of physical distance, where closer objects are easier to see than distant objects, where near and far is defined as distance, in words or lines, from the current reading focal point. These concepts are illustrated in FIGS. 3A, 3B, 4B, 4C.

FIGS. 3A-B also illustrate how variable font size, smaller for previous text, larger for more current text and the reading focal point can be used to condense content in a manner supportive of Saccadic cognition, where text size and emphasis reflect relative value to Saccadic cognition; the farther away the preceding text the smaller the font, since the less likely you'll rescan it while reading. Close to the current reading focal point, text can become larger and better emphasized, thus easier to see. These combined methods allow more text to appear in less space on the screen.

The invention can track saccadic eye movements to dynamically highlight the exact words content corresponding to areas of the user's shifting gaze. Both individual and macro user population analysis can be used to predict in advance the most likely saccadic related gaze targets, allowing them to be better highlighted.

FIG. 4A shows a famous Steve Jobs quote being typed in normal display format. FIG. 4B shows the same quote in condensed format, with starting lines of the quote shown in background mode, and ending lines in foreground mode format. FIG. 4C shows how the more ‘distant’ previous quote text can be further condensed by use of smaller font size.

### Notes and Definitions

Abbreviated words and phrases examples normally refer to both upper and lower case or case insensitive versions of the words, despite what is shown.
“->”=shorthand for ““becomes or abbreviates to one of the following”.
App=computer program software application, on any computer system, but typically running on a mobile device.
Cloud=a remote computer connecting to a local device across a network, typically via internet.
Content=any information displayed on a computer screen, which can consist of any combination of text, characters, words, word fragments, sentences, phrases, paragraphs, text, font emphasis, highlighting (graphics (outline shapes, translucence, 2d or 3d display orientation or direction, etc.), colors, styles like bold, italic, etc.), symbols and images, can be Web and or application based, including advertising, and can also be direct user input such as typed in text messages or emails, etc.
Context=the state of a device, including both hardware, software, along with external conditions affecting usability, such as motion, lighting, user physical and mental states, etc.
Implied Context=content related words implied or implicitly understood from previous content, and therefore may be redundant. Example: “a new smart watch has arrived. It's huge, but nice”. The word “it's” is implied by the previous sentence.
Context Hints=words which signal key implied context, thus allowing for additional word abbreviation.
Highlight=any combination of methods for improving content visibility, clarity or emphasis, such as text font bolding, italics, distinct colors, larger size, underlining, distinct fonts, graphics like shapes, border outlines, 2D and 3D orientation, etc.
Information Density=the total amount of data (text and or images) which are quickly and easily visible, readable and comprehensible at any given time on a given unit of screen display area.
JSON=JavaScript Object Notation, (http://en.wikipedia.org/wiki/JSON) a lightweight form of XML data representation, typically used in Web applications.
Macro User Populations (Macro Populations)=large numbers of users, potentially millions, using a particular app, in similar situations, on a specific similarly configured mobile device. Data about such macro populations is typically collected and statistically analyzed to learn how to improve and highly customize mobile device UI ergonomics.
Mobile Device (or ‘Device’)=a small, portable mobile computer device, typically wireless and internet capable, such as a smartphone, tablet, smart watch (wearable), etc.
Saccades Eye Movements: Saccades (http://en.wikipedia.org/wiki/Saccade) are quick, simultaneous movements of both eyes in the same direction Initiated cortically by the frontal eye fields (FEF), or subcortically by the superior colliculus, saccades serve as a mechanism for fixation, rapid eye movement, and the fast phase of optokinetic nystagmus. Saccadic eye movements describe how when reading our eyes frequently unconsciously scan back to previously viewed material (http://en.wikipedia.org/wiki/Eye_movement_in_reading).
Sounds Like=words spelled closer to what they sound like, entire words or just word sections or fragments (e.g. prefixes, suffixes, etc.), but where the meaning remains reasonably clear and unambiguous, particularly from the local surrounding context. Can also be applied to entire short phrases.
UI or ui=user interface, (http://en.wikipedia.org/wiki/User_interface) typically meaning the interactive controls on digital communication devices, like mobile device smartphone touch screen virtual keyboards, content display areas and menu systems, etc. It can also include physical device buttons and other controls.
Wearable=a small mobile digital device, usually wirelessly connected to other mobile devices or the internet, typically worn by the user, for example a smart watch from companies like Apple and Samsung.
XML=Extensible Markup Language, (http://en.wikipedia.org/wiki/XML) a common universal computer data format.

### REFERENCES/RESOURCES

The most common English language words:

http://en.wikipedia.org/wiki/Most common words in English

the first 25 words make up about one-third of all printed material in English, and that the first 100 make up about one-half of all written material.

1. A method of processing a passage of text on a computer system to reduce the number of letters displayed while maintaining unambiguous meaning to a reader, comprising:
a. determining an implied context for the passage based on a noun at the start of the passage, wherein the implied context is explicitly displayed as a hint to the reader;
b. removing the implied context from the passage to give a reduced passage;
c. processing the reduced passage on the computer system to abbreviate one or words of the text in the reduced passage to give an abbreviated reduced passage, wherein the abbreviated text is unambiguous;
d. displaying on a computer screen the hint in an adjacent position to the abbreviated reduced passage.

2. The method of claim 1, wherein the hint is processed on the computer system to abbreviate the hint, and displaying on a computer the abbreviated hint adjacent to the abbreviated reduced passage.

3. A text editing screen for a space constrained computer display, comprising:
a. a computer with a space constrained touch sensitive screen;
b. displaying background comprising a passage of text on the screen, wherein a computer user desires to edit the passage;
c. selecting a focus point in the passage;
d. displaying a transparent foreground keyboard comprising virtual computer keys displayed on the computer display, wherein the foreground keyboard overlaps, overlays, and floats over the passage of text;
e. wherein the foreground keyboard and background text are distinguished from each other by visual cues on the screen.

4. The screen of claim 3, wherein the visual cues are selected from one or more of keys displayed with distinct fonts; keys displayed with shades; keys displayed with colors; keys displayed with borders; and highlight graphics comprising a faded and de-emphasized background, and darker or brighter keys in the foreground.

5. The screen of claim 3, wherein the foreground keyboard approximates a standard QWERTY layout.

6. A method for editing text on a space constrained computer display, comprising:
a. a computer with a space constrained touch sensitive screen;
b. displaying background comprising a passage of text on the screen, wherein a computer user desires to edit the passage;
c. selecting a focus point in the passage;
d. displaying a transparent foreground keyboard comprising virtual computer keys displayed on the computer display, wherein the foreground keyboard overlaps, overlays, and floats over the passage of text;
e. wherein the foreground keyboard and background text are distinguished from each other by visual cues on the screen; and
f. wherein the user edits the background text by selecting one or more foreground keys.
